(19) United States
(12) Patent Application Publication
(10) Pub. No.: US 2020/0266994 A1
(43) Pub. Date: Aug. 20, 2020

(54) SYSTEM AND METHOD FOR IMPLEMENTING BLOCKCHAIN TRANSACTIONS USING A CONSUMER APPLIANCE

(71) Applicant: Haier US Appliance Solutions, Inc., Wilmington, DE (US)

(72) Inventor: Jeff Donald Drake, Louisville, KY (US)

(21) Appl. No.: 16/276,700

(22) Filed: Feb. 15, 2019

(51) Int. Cl. H04L 9/32; G06Q 20/40; H04L 9/06

(52) U.S. Cl. CPC H04L 9/3239; H04L 2209/38; H04L 9/0637; G06Q 20/401

(57) ABSTRACT

Consumer appliances and methods for their use are generally provided herein. A method may include obtaining a purchase authorization from a user of the consumer appliance authorizing the purchase of a software application, generating a discrete block of a blockchain in response to obtaining the purchase authorization, and transmitting the discrete block to a blockchain network wirelessly connected to the consumer appliance. The method may further include downloading and implementing the software application using the appliance controller and graphical user interface.

### FIELD OF THE INVENTION

The present subject matter relates generally to facilitating secure transactions using appliances, and more particularly to the implementation of blockchain transactions to purchase software applications using consumer appliances.

### BACKGROUND OF THE INVENTION

Modern consumer appliances, such as refrigerator appliances, often include one or more features for communicating or interacting with a user. For example, an electronic display or loudspeaker may be included with a consumer appliance in order to show or play programmed alerts, instructional text, conditions within the appliance, etc. In addition, such refrigerator appliances may run software applications to perform various tasks, e.g., as written or developed by the software programmer or app developer.

However, to permit a consumer to purchase and download a software application from a developer, conventional appliances require the user to use another device, such as a computer or mobile phone, to make the purchase directly from the developer and authorize payment to the developer for the application. Such a process is cumbersome and does not promote simple and secured transactions. Alternatively, consumer appliances may include electronic hardware technology for facilitating such a transaction through the appliance, but this hardware is typically not as secure as transacting through a computer with a third party and is more prone to hacking, resulting in users who are less comfortable providing credit card or bank information through the appliance. Therefore, conventional consumer appliances do not facilitate an environment where consumers are comfortable making purchases through the appliance and developers are comfortable developing software for such appliances.

Accordingly, an environment permitting secured, decentralized transactions between a consumer and a developer through one or more appliances would be useful. More particularly, a consumer appliance that is capable of blockchain transactions with a software developer to permit the purchase of software applications would be especially beneficial.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a method of operating a consumer appliance is provided. The method includes obtaining a purchase authorization from a user of the consumer appliance authorizing the purchase of a software application, generating a discrete block of a blockchain in response to obtaining the purchase authorization, and transmitting the discrete block to a blockchain network wirelessly connected to the consumer appliance.

In another exemplary aspect of the present disclosure, an appliance is provided including a user interface and a network interface communicatively coupling the appliance to a blockchain network. A controller is operably coupled with the user interface for obtaining a purchase authorization from a user of the appliance authorizing the purchase of a software application, generating a discrete block of a blockchain in response to obtaining the purchase authorization, and transmitting the discrete block to the blockchain network.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a consumer appliance according to exemplary embodiments of the present disclosure.

FIG. 2 provides a schematic view of a networked system according to exemplary embodiments of the present disclosure.

FIG. 3 provides a flow chart illustrating a method of operating a consumer appliance within a system according to exemplary embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Within the present disclosure, the terms “includes” and “including” are intended to be inclusive in a manner similar to the term “comprising.” Similarly, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components.

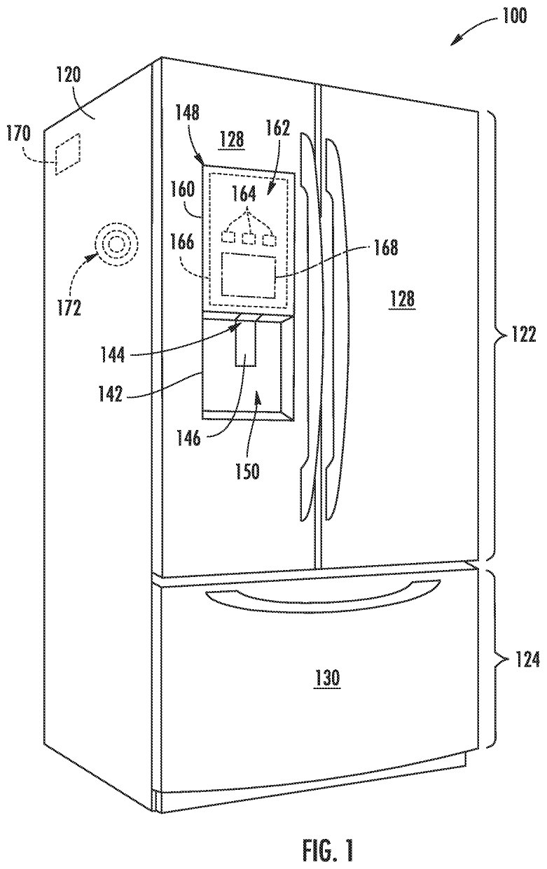

Turning now to the figures, FIG. 1 illustrates a consumer appliance 100 according to exemplary embodiments of the present disclosure. Generally, consumer appliance 100 includes a cabinet 120 on which one or more communications features (e.g., an graphical user interface 160 or a loudspeaker 172) are mounted. In the exemplary embodiments of FIG. 1, consumer appliance is provided as a refrigerator appliance 100. However, as would be understood, consumer appliance 100 may be provided as any suitable consumer appliance (e.g., a microwave, oven appliance, cooktop appliance, range hood, dishwasher appliance, washing machine appliance, dryer appliance, etc.).

As generally illustrated in FIG. 1, refrigerator appliance 100 includes a housing or cabinet 120 that defines chilled chambers for receipt of food items for storage. In particular, cabinet 120 defines a fresh food chamber 122 positioned at or adjacent the top of cabinet 120 and a freezer chamber 124 arranged at or adjacent the bottom of cabinet 120. As such, refrigerator appliance 100 is generally referred to as a bottom mount refrigerator. It is recognized, however, any other suitable appliance or refrigerator style, such as, for example, a top mount refrigerator appliance, a side-by-side style refrigerator appliance, etc. may be provided. Consequently, the description set forth herein is for illustrative purposes only and is not intended to be limiting in any aspect to any particular refrigerator chamber configuration or, as noted above, any particular style of appliance.

Refrigerator doors 128 are rotatably hinged to an edge of cabinet 120 for selectively accessing fresh food chamber 122. In addition, a freezer door 130 is arranged below refrigerator doors 128 for selectively accessing freezer chamber 124. Freezer door 130 is attached to a freezer drawer (not shown) slidably mounted within freezer chamber 124. Refrigerator doors 128 and freezer door 130 are shown in the closed configuration in FIG. 1.

In some embodiments, refrigerator appliance 100 also includes a dispensing assembly 140 for dispensing liquid water or ice. Dispensing assembly 140 includes a dispenser 142 positioned on or mounted to an exterior portion of refrigerator appliance 100 (e.g., on one of refrigerator doors 128). Dispenser 142 includes a discharging outlet 144 for accessing ice and liquid water. An actuating mechanism 146, shown as a paddle, is mounted below discharging outlet 144 for operating dispenser 142. In alternative exemplary embodiments, any suitable actuating mechanism may be used to operate dispenser 142. For example, dispenser 142 can include a sensor (such as an ultrasonic sensor) or a button rather than the paddle.

Discharging outlet 144 and actuating mechanism 146 are an external part of dispenser 142 and are mounted in a dispenser recess 150. Dispenser recess 150 is positioned at a predetermined elevation convenient for a user to access ice or water and enabling the user to access ice without the need to bend-over and without the need to open refrigerator doors 128.

As shown, a user interface 148 is provided for user engagement (e.g., input or output) with refrigerator appliance 100. For example, user interface 148 may generally provide for controlling the mode of operation or communicating information about appliance operation. Any suitable type of user input 164 (e.g., buttons, switches, touchscreens, etc.) may be provided to initiate or direct operation of the refrigerator appliance 100.

In certain embodiments, user interface 148 includes an image monitor or graphical user interface 160, which may be any suitable type of mechanism for visually presenting a digital (e.g., interactive) image. For example, graphical user interface 160 may be a liquid crystal display (LCD), a plasma display panel (PDP), a cathode ray tube (CRT) display, etc. Thus, graphical user interface 160 includes a display surface 162 (e.g., screen or display panel) at which the digital image is presented or displayed as an optically-viewable picture (e.g., static image or dynamic video) to a user. The optically-viewable picture may correspond to any suitable signal or data received or stored by refrigerator appliance 100 (e.g., at controller 170). As an example, graphical user interface 160 may implement all or a portion of a software application. Optionally, the visual advertisement may be limited to a predetermined subportion area 168 that is less than the total viewable area 166 defined on the display surface 162.

According to the illustrated embodiment, graphical user interface 160 (or GUI) allows a user to select or manipulate various operational features of refrigerator appliance 100. During use of such GUI embodiments, a user may engage, select, or adjust the image presented at graphical user interface 160 through any suitable input, such as gesture controls detected through a camera assembly, voice controls detected through one or more microphones, associated touch panels (e.g., capacitance or resistance touch panel) or sensors overlaid across the display surface 162, etc.

In additional or alternative embodiments, refrigerator appliance 100 includes one or more loudspeakers 172, which may be any suitable type of mechanism for projecting or generating an audible sound wave. For example, a loudspeaker 172 may be provided as a dynamic loudspeaker, piezoelectric speaker, electrostatic speaker, etc. Thus, the loudspeaker 172 may generally project an analog or digital signal as one or more audible sound waves to be heard by a user. The audible sound waves may correspond to any suitable signal or data received or stored by refrigerator appliance 100 (e.g., at controller 170). As an example, loudspeakers 172 implement all or a portion of a software application in the form of an audible message (e.g., in coordination with an optically viewable image at the graphical user interface 160 or, alternatively, in isolation and without any accompanying image).

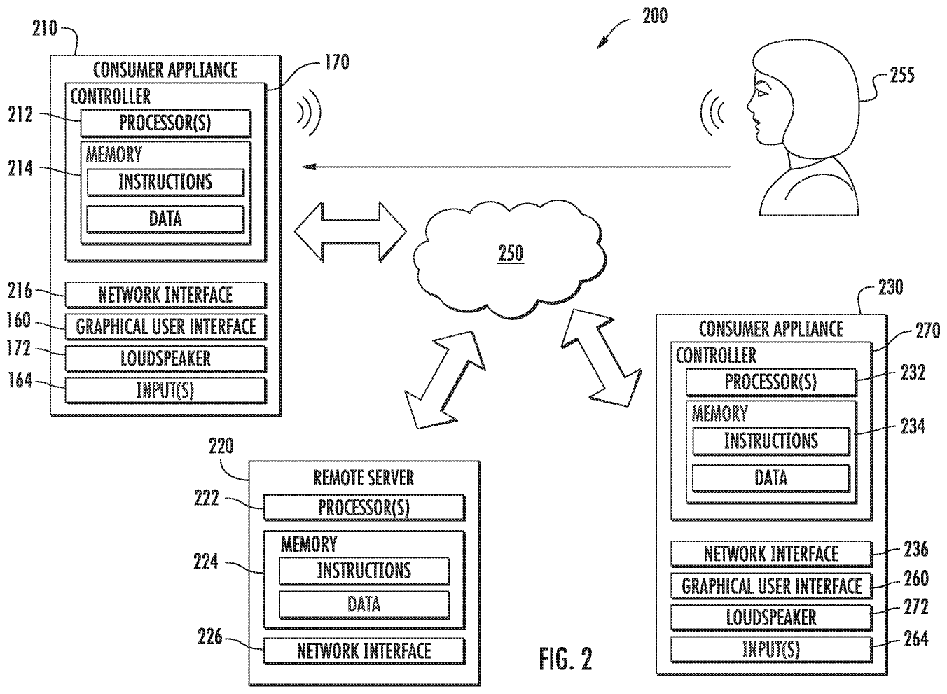

Operation of the refrigerator appliance 100 can be generally controlled or regulated by a controller 170 that is operably coupled to user interface 148 and other components of refrigerator appliance 100. In some embodiments, user interface 148 provides selections for user manipulation of the operation of refrigerator appliance 100. As an example, user interface 148 may provide for selections between whole or crushed ice, chilled water, or specific modes of operation. More specifically, according to exemplary embodiments, user interface may implement one or more software applications. In response to one or more input signals (e.g., from local input sensors, user manipulation of user interface 148, or remote signals transmitted by a remote server 220), controller 170 may operate various components of the refrigerator appliance 100. For example, controller 170 may receive a remote signal from a remote server 220 (FIG. 2) that includes a software application which may be downloaded and implemented using appliance 100. Specifically, the software application may be implements using controller 170 to direct operation of graphical user interface 160, loudspeaker 172, or any other components of appliance 100. As used herein, the terms “software application,” “software,” “application,” “app,” and the like are intended to refer generally to computer software designed to perform a group of coordinated functions, tasks, or activities for the benefit of the user.

Turning now to FIG. 2, a schematic view of a networked system 200, including a primary consumer appliance 210 (e.g., refrigerator appliance 100—FIG. 1, or any other suitable appliance, as described above), one or more secondary consumer appliances 230, and a remote server 220. As shown, primary consumer appliance 210 can be communicatively coupled with network 250 and various other nodes, such as a remote server 220 and one or more secondary consumer appliances 230. Moreover, one or more users 255 can be in operative communication with primary consumer appliance 210 via various methods (e.g., voice control, gesture recognition, or engagement with one or more user inputs 164). Alternatively, users 255 may communicate with or operate consumer appliance 210 using a mobile device, e.g., a cell phone, a tablet, a computer, or any other device operably coupled with consumer appliance 210.

As noted above, a primary consumer appliance 210 (e.g., refrigerator appliance 100—FIG. 1) may include a controller 170 operably coupled to one or more user inputs 164, graphical user interface 160, or loudspeaker 172. Controller 170 may include one or more processors 212 and one or more memory devices 214 (i.e., memory). The one or more processors 212 can be any suitable processing device (e.g., a processor core, a microprocessor, an ASIC, a FPGA, a microcontroller, etc.) and can be one processor or a plurality of processors that are operatively connected. The memory device 214 can include one or more non-transitory computer-readable storage mediums, such as RAM, ROM, EEPROM, EPROM, flash memory devices, magnetic disks, etc., and combinations thereof. The memory devices 214 can store data and instructions that are executed by the processor 212 to cause the primary consumer appliance 210 to perform operations. For example, instructions could be instructions for receiving purchase authorizations, commencing financial transactions, downloading software applications, implementing such software applications for example using graphical user interface 160, generating sound waves at loudspeaker 172, etc. The memory devices 214 may also include data, such as identification data corresponding to the individual primary consumer appliance 210, stored blockchain files, stored software files, etc., that can be retrieved, manipulated, created, or stored by processor 212.

Controller 170 includes a network interface 216 such that primary consumer appliance 210 can connect to and communicate over one or more networks (e.g., network 250) with one or more network nodes. Network interface 216 can be an onboard component of controller 170 or it can be a separate, off board component. Controller 170 can also include one or more transmitting, receiving, or transceiving components for transmitting/receiving communications with other devices communicatively coupled across network 250. Additionally or alternatively, one or more transmitting, receiving, or transceiving components can be located off board controller 170.

Network 250 can be any suitable type of network, such as a local area network (e.g., intranet), wide area network (e.g., internet), low power wireless networks [e.g., Bluetooth Low Energy (BLE)], or some combination thereof and can include any number of wired or wireless links. In general, communication over network 250 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL).

In some embodiments, a remote server 220, such as a web server, is in operative communication with primary consumer appliance 210. The remote server 220 can be used to host an information database (e.g., software applications, blockchain files, payment data files, etc.). The server can be implemented using any suitable computing device(s). The remote server 220 may include one or more processors 222 and one or more memory devices 224 (i.e., memory). The one or more processors 222 can be any suitable processing device (e.g., a processor core, a microprocessor, an ASIC, a FPGA, a microcontroller, etc.) and can be one processor or a plurality of processors that are operatively connected. The memory device 224 can include one or more non-transitory computer-readable storage mediums, such as RAM, ROM, EEPROM, EPROM, flash memory devices, magnetic disks, etc., and combinations thereof. The memory devices 224 can store data and instructions which are executed by the processor 222 to cause remote server 220 to perform operations. For example, instructions could be instructions could be instructions for facilitating financial transactions, downloading software applications, implementing software applications, etc. The data can be stored in one or more databases. The one or more databases can be connected to remote server 220 by a high bandwidth LAN or WAN, or can also be connected to remote server 220 through network 250. The one or more databases can be split up so that they are located in multiple locales.

Remote server 220 includes a network interface 226 such that remote server 220 can connect to and communicate over one or more networks (e.g., network 250) with one or more network nodes. Network interface 226 can be an onboard component or it can be a separate, off board component. In turn, remote server 220 can exchange data with one or more nodes over the network 250. In particular, remote server 220 can exchange data with primary consumer appliance 210. Although not pictured, it is understood that remote server 220 may further exchange data with any number of client devices over the network 250. The client devices can be any suitable type of computing device, such as a general purpose computer, special purpose computer, laptop, desktop, integrated circuit, mobile device, smartphone, tablet, or other suitable computing device. In some embodiments, blockchain files such as discrete blocks, may be exchanged between multiple consumer appliances (e.g., consumer appliances 210, 230).

In certain embodiments, primary consumer appliance 210 is in operable communication with one or more secondary consumer appliances 230 via network 250. For example, the primary consumer appliance 210 and one or more secondary consumer appliances 230 may be organized into peer-to-peer communication. For example, the appliances 210, 230 may be located within at least two different residences (e.g., houses, apartments, etc.) and may be owned by at least two or more owners. In turn, controller 170 of primary consumer appliance 210 may exchange signals (e.g., relating to blockchain files) with secondary consumer appliance 230. Together, the primary consumer appliance 210 and one or more secondary consumer appliances 230 can form an appliance network wirelessly connected to network 250 (e.g., separate from remote server 220). In optional embodiments, the appliance network is blockchain network such that discrete blocks can be exchanged across the appliance network and duplicated on multiple consumer appliances (e.g., primary consumer appliance 210 and secondary appliances 230 as part of a blockchain ledger).

As used herein, the terms “blockchain,” “blockchain technology,” “block,” “blockchain protocol,” or the like are intended to refer generally to blockchain technology, which is a shared, trusted, public ledger of transactions, that everyone can inspect but which no single user controls. It is a distributed database that maintains a continuously growing list of transaction data records, cryptographically secured from tampering and revision. The blockchain protocal may operate through a network, such as a peer-to-peer (P2P) network of computers that run such protocol and store an identical copy of the ledger of transactions—i.e., the chain of blocks or encrypted transactions.

The one or more secondary consumer appliances 230 may be of the same type of appliance as the primary consumer appliance 210 or, alternatively, as a different type of appliance. As an example, the primary consumer appliance 210 and secondary consumer appliances 230 may both be provided as a refrigerator appliance. As an alternative example, the primary consumer appliance 210 may be provided as a refrigerator appliance while the secondary consumer appliance 230 is provided as an oven appliance (or another suitable appliance), as would be understood.

As illustrated, secondary consumer appliance 230 may include a controller 270 operably coupled to one or more user inputs 264, graphical user interface 260, or loudspeaker 272. Controller 270 may include one or more processors 232 and one or more memory devices 234 (i.e., memory). The one or more processors 232 can be any suitable processing device (e.g., a processor core, a microprocessor, an ASIC, a FPGA, a microcontroller, etc.) and can be one processor or a plurality of processors that are operatively connected. The memory device 234 can include one or more non-transitory computer-readable storage mediums, such as RAM, ROM, EEPROM, EPROM, flash memory devices, magnetic disks, etc., and combinations thereof. The memory devices 234 can store data and instructions that are executed by the processor 232 to cause the secondary consumer appliance 230 to perform operations. For example, instructions could be instructions for receiving purchase authorizations, commencing financial transactions, downloading software applications, implementing such software applications for example using graphical user interface 260, generating sound waves at loudspeaker 272, etc. The memory devices 234 may also include data, such as such as identification data corresponding to the individual secondary consumer appliance 230, stored blockchain files, stored software files, etc., that can be retrieved, manipulated, created, or stored by processor 232.

Controller 270 includes a network interface 236 such that secondary consumer appliance 230 can connect to and communicate over one or more networks (e.g., network 250) with one or more network nodes. Network interface 236 can be an onboard component of controller 270 or it can be a separate, off board component. Controller 270 can also include one or more transmitting, receiving, or transceiving components for transmitting/receiving communications with other devices communicatively coupled across network 250. Additionally or alternatively, one or more transmitting, receiving, or transceiving components can be located off board controller 270.

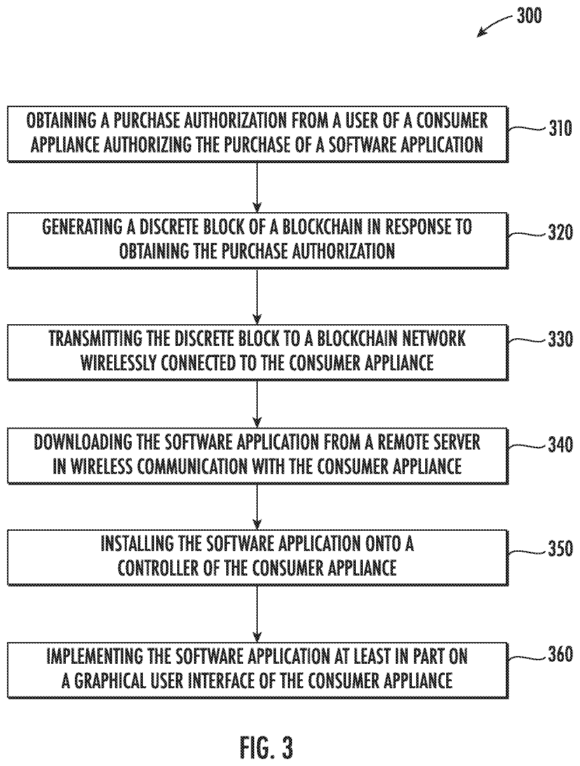

Referring now to FIG. 3, various methods may be provided for use with system 200 in accordance with the present disclosure. In general, the various steps of methods as disclosed herein may, in exemplary embodiments, be performed by the controller 170 part of an operation that the controller 170 is configured to initiate. During such methods, controller 170 may receive inputs and transmit outputs from various other components of the system 200. For example, controller 170 may send signals to and receive signals from remote server 220 or one or more secondary consumer appliances 230 (e.g., as part of a wireless peer-to-peer communications network). In particular, the present disclosure is further directed to methods, as indicated by 300, for operating a consumer appliance (e.g., primary consumer appliance 210—FIG. 2). Such methods advantageously provide a secure, decentralized appliance ecosystem which permits software developers to develop and sell software applications directly to users of consumer appliances and receiving secure payment utilizing blockchain technology.

Method 300 includes, at step 310, obtaining a purchase authorization from a user of a consumer appliance authorizing the purchase of a software application. According to exemplary embodiments, the user may provide a purchase authorization in any suitable manner and using any suitable device. For example, according to one embodiment, the purchase authorization may be received when a user manipulates user inputs 164 or graphical user interface 160 on refrigerator appliance 100. In this regard, for example, a user may manipulate graphical user interface 160 to enter a software application marketplace where they may search, select, and purchase desired software applications.

According to alternative embodiments, the user may use a device remote from refrigerator appliance 100 for performing these functions. For example, a user may use a mobile phone, a tablet, a computer, or another mobile device to communicate wirelessly with refrigerator appliance 100, e.g., through a home network, through Bluetooth connectivity, etc. Therefore, the present subject matter is not intended to be limited to the specific appliance, user interface, specific software applications, etc.

According to exemplary embodiments, the purchase authorization further includes an authorization to perform a financial transaction with a developer of the software application. For example, a user may store credit card and/or bank information directly on refrigerator appliance 100, e.g., encrypted in memory 214 of controller 170. Upon authorizing the purchase of a software application, a communication may be sent to the user's bank or another third-party for commencing a financial transaction with the developer or a third-party associated with the developer. In this manner, the software developer may receive payment in exchange for transmitting an authorization code, software, or another key permitting a user to download, implement, and/or operate the purchased software application.

Notably, the consumer appliance, e.g., refrigerator appliance 100, or any other consumer appliance which may be used with the blockchain network described herein, may include an application program interface upon which the software applications within the app store may be developed. In this regard, the application program interface may be operably coupled with the various components of the appliance for implementing a program, such as the graphical user interface 160, sensors, loudspeakers 172, or other interactive components of refrigerator appliance 100. Notably, the use of a common application program interface may permit and facilitate simplified software application development for the developer and thus improve the appliance ecosystem for software application development.

Step 320 includes generating a discrete block of a block chain in response to obtaining the purchase authorization. In this regard, using block chain technology, the consumer appliance, e.g., refrigerator appliance 100, may generate the discrete block. For instance, as is understood, each block of the blockchain can contain a hash of a previous block, a timestamp, financial transaction data, and use specific data or content.

Step 330 includes transmitting the discrete block to a block chain network wirelessly connected to the consumer appliance. In this regard, the discrete block may be appended to the end of the block chain ledger of transactions. Some or all of the appliances connected to the block chain network may then authorize or approve the discrete block before it is verified as an authentic transaction and permanently entered into the blockchain. Thus, the discrete block of 320 may be duplicated across the blockchain network. As described above, blockchain network may include a plurality of consumer appliances organized in peer-to-peer communication (e.g., as a wireless peer-to-peer network). In optional embodiments, the remote server is separated from the blockchain network, and thus is not required to store a duplicate copy of the corresponding blockchain.

After the purchase authorization has been approved and the transaction has been appended to the block chain ledger in steps 310 through 330, the consumer appliance may then download and implement the software application. Specifically, step 340 may include downloading the software application from a remote server in wireless communication with the consumer appliance. Step 350 may include installing the software application on to a controller of the consumer appliance and step 360 may include implementing the software application at least in part on a graphical user interface of the consumer appliance. For example, the consumer appliance may receive a payment signal or transaction authentication signal in response to transmitting the discrete block and having a block approved and block chain ledger. According to other embodiments, the download process may be commenced simultaneously with the generation of the discrete block or the transmission of the discrete block. In such an embodiment, for example, the developer may send an encrypted key or authorization for implementation of the software application upon receiving approved financial transaction. According to various embodiments, the software application may be stored locally on the consumer appliance or may be stored remotely and temporarily transmitted to the consumer appliance. Optionally, the software application may be received from a remote server in wireless communication with consumer appliance, as described above.

FIG. 3 depicts an exemplary control method having steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of the methods are explained using refrigerator appliance 100 and network 200 as an example, it should be appreciated that these methods may be applied to facilitate block chain technology and software purchase transactions in any other suitable system and types of appliances.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a consumer appliance, the method comprising:
obtaining a purchase authorization from a user of the consumer appliance authorizing the purchase of a software application;
generating a discrete block of a blockchain in response to obtaining the purchase authorization; and
transmitting the discrete block to a blockchain network wirelessly connected to the consumer appliance.

2. The method of claim 1, wherein the purchase authorization comprises an authorization to perform a financial transaction with a developer of the software application.

3. The method of claim 1, wherein the blockchain network comprises a plurality of consumer appliances organized in peer-to-peer communication.

4. The method of claim 3, wherein the plurality of consumer appliances are located within at least two different residences or are owned by at least two different consumers.

5. The method of claim 1, wherein obtaining a purchase authorization comprises:
receiving a user input through a graphical user interface of the consumer appliance.

6. The method of claim 5, further comprising:
implementing the software application at least in part on the graphical user interface of the consumer appliance.

7. The method of claim 1, further comprising:
providing an application store on a graphical user interface of the consumer appliance where the consumer may select and purchase one or more software applications.

8. The method of claim 1, further comprising:
receiving a payment signal in response to transmitting the discrete block.

9. The method of claim 1, wherein the discrete block comprises a timestamp and financial transaction data.

10. The method of claim 1, further comprising:
installing the software application onto a controller of the consumer appliance.

11. The method of claim 10, wherein the software application is received from a remote server in wireless communication with the consumer appliance.

12. The method of claim 11, wherein the remote server is separated from the blockchain network.

13. The method of claim 1, wherein the consumer appliance is a refrigerator appliance.

14. The method of claim 1, wherein the consumer appliance comprises an application program interface upon which the software application was developed.

15. The method of claim 14, wherein the application program interface is operably coupled with one or more of a graphical user interface, sensors, and other components of the consumer appliance.

16. An appliance comprising:
a user interface;
a network interface communicatively coupling the appliance to a blockchain network; and
a controller operably coupled with the user interface, the controller being configured for:
obtaining a purchase authorization from a user of the appliance authorizing the purchase of a software application;
generating a discrete block of a blockchain in response to obtaining the purchase authorization; and
transmitting the discrete block to the blockchain network.

17. The appliance of claim 16, wherein the user interface comprises a graphical user interface, and wherein obtaining a purchase authorization comprises:
receiving a user input through a graphical user interface of the appliance.

18. The appliance of claim 17, wherein the controller if further configured for:
implementing the software application at least in part on the graphical user interface of the appliance.

19. The appliance of claim 16, wherein the software application is received from a remote server in wireless communication with the appliance.

20. The appliance of claim 16, wherein the appliance is a refrigerator appliance.
